(19) United States
(12) Patent Application Publication
(10) Pub. No.: US 2023/0113982 A1
(43) Pub. Date: Apr. 13, 2023

(54) MULTIPLE METHODS FOR CREATING EFFICIENCY WITHIN A SYSTEM

(71) Applicant: Jason Clarke, RCT Wales (GB)

(72) Inventor: Jason Clarke, Wales (GB)

(21) Appl. No.: 17/964,854

(22) Filed: Oct. 12, 2022

Related U.S. Application Data
(60) Provisional application No. 63/255,023, filed on Oct. 13, 2021.
(60) Provisional application No. 63/346,326, filed on May 27, 2022.
(60) Provisional application No. 63/358,282, filed on Jul. 5, 2022.
(60) Provisional application No. 63/359,234, filed on Jul. 8, 2022.
(60) Provisional application No. 63/405,908, filed on Sep. 13, 2022.
(60) Provisional application No. 63/406,279, filed on Sep. 14, 2022.
(60) Provisional application No. 63/406,740, filed on Sep. 15, 2022.
(60) Provisional application No. 63/406,746, filed on Sep. 15, 2022.
(60) Provisional application No. 63/408,135, filed on Sep. 20, 2022.
(60) Provisional application No. 63/410,650, filed on Sep. 28, 2022.
(60) Provisional application No. 63/410,825, filed on Sep. 28, 2022.
(60) Provisional application No. 63/411,223, filed on Sep. 29, 2022.

(51) Int. Cl. G06F 16/951; G06F 16/9535; G06F 3/0481

(52) U.S. Cl. CPC G06F 16/951; G06F 16/9535; G06F 3/0481

(57) ABSTRACT

A system is provided in which a user interacts with other users by liking and matching with them. Each time a user likes or matches with another user, they must rank that user in relation to the other users they have already liked or matched with. Each user's rank is unique and signifies the level of priority that the other user feels towards them. The rank given is displayed to the other user. Users continually adjust the ranking of others user as they use the system, ranking other users a higher or lower priority as they like and match with more other users and change their priority of the people they want to communicate with. According to one implementation, after rankings have been established in this manner, the system only allows users to have a select number of open messages with other users at any one time, to reduce the negative effects of too many messages such as ghosting or poor communication. So, for example, the settings may allow 3 open messages at any one time, so in the matches area, rank positions 1, 2 and 3 will qualify to open a message.

### CROSS-REFERENCE TO RELATED APPLICATIONS; BENEFIT CLAIM

This application claims the benefit of:

Provisional Application 63255023, filed Oct. 13, 2021;
Provisional Application 63346326, filed May 27, 2022;
Provisional Application 63358282, filed Jul. 5, 2022;
Provisional Application 63359234, filed Jul. 8, 2022;
Provisional Application 63405908, filed Sep. 13, 2022;
Provisional Application 63406279, filed Sep. 14, 2022;
Provisional Application 63406740, filed Sep. 15, 2022;
Provisional Application 63406746, filed Sep. 15, 2022;
Provisional Application 63408135, filed Sep. 20, 2022;
Provisional Application 63410650, filed Sep. 28, 2022;
Provisional Application 63410825, filed Sep. 28, 2022; and
Provisional Application 63411223, filed Sep. 29, 2022;
the entire contents of each of which are hereby incorporated by reference as if fully set forth herein, under 35 U.S.C. § 119(e).

### FIELD OF THE INVENTION

The invention relates generally to users of a transparent rank online dating system and process.

### BACKGROUND

An online dating system may enable its users to interact with it, and with each other through it. The online dating system may, with input from a user, create and store in the online dating system a user profile associated with the user. The user profile may include information about the personality and personal interest of the user, and, with input from the user, allow the user to present information about themselves to other users using text, photos, videos, and audio. The online dating system may also provide other services to the users to facilitate communication between one another such as sending messages, voice messages, voice and video calls, liking other user profiles, and advertisements.

The online dating system may send over one or more networks content or messages related to its services to a mobile or other computing device of a user. A user may also install software applications on a mobile or other computer device of the user for accessing a user profile and other data of the online dating system.

Online dating systems currently operational in the market have different rules that define how users may interact with each other.

The original system created in the market was an open message system, where all users can send message all users. This method results in popular users getting too many messages, having a negative experience, and no longer using the service.

Then a system known as a double blind opt in system was created, where the user views profiles one by one and must choose interested or not interested on that profile to move forward to view the next profile, with the outcoming being that when two people both show interest in each other, a message between them is opened. This system is inherently flawed. Because the system's only output from two profiles showing mutual interest is to simply open a message, it leads to many users who use the system “liking” and opening a high number of messages with other users, leading to a poor level of interaction between the users and a lower quality of communication.

A better solution is needed. Specifically, it would be desirable to have a new online dating system that reduces the amount of liking, matching and open conversations. Instead, users should be able to make more informed choices about who they like and who they match with. Also, users need to be more focused on the open messages they already have, to create more quality and meaningful connections, rather than creating a large volume of connections that lead to diluted interaction, “ghosting” (not replying) or deletion without accountability for the actions that caused.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

Some embodiments of the present invention are illustrated as an example and are not limited by the figures of the accompanying drawings, in which like references may indicate similar elements and in which:

FIG. 1 illustrates a flow chart of a management system of an online dating system, according to an implementation.

FIG. 2 shows an example block diagram of an exemplary online dating system in accordance with the present disclosure, configured to facilitate communications between at least two users.

FIG. 3-7 are continuations of the flowchart illustrated in FIG. 1.

FIG. 8 shows an flowchart for a preferred online dating software application for use in one or more user systems of the online dating system illustrated in FIG. 2.

FIG. 9E shows an example homepage of the online dating software application.

FIG. 9A shows one embodiment of the SEARCH area of the online dating software application, displaying the profiles of other users sorted by order of distance from the user.

FIG. 9B shows one embodiment of the SEARCH area of the online dating software application, displaying the profiles of other users sorted by order of distance from the user, with the user selecting “like”.

FIG. 9C shows one embodiment of the SEARCH area of the online dating software application, displaying the profiles of other users sorted by order of distance from the user, with the user likes now moved to another area.

FIG. 9D shows an example user profile page of the online dating software application.

FIG. 9F shows one embodiment of the WHO YOU LIKE area of the online dating software application, displaying the profiles of users that our user has shown attraction to, in rank order depending on the desires of our user.

FIG. 9G shows one embodiment of the WHO YOU LIKE area of the online dating software application, showing the selecting of a profile in readiness to rank into a new position on the rank table.

FIG. 9H shows one embodiment of the WHO YOU LIKE area of the online dating software application, showing the movement of a profile from one rank to another as it slides to a new position.

FIG. 9I shows one embodiment of the WHO YOU LIKE area of the online dating software application, showing the completed movement of the profile from one rank to another.

FIG. 9J shows one embodiment of the WHO LIKES YOU area of the online dating software application, displaying the profiles of other users that are currently showing attraction to our user, arranged in order of best rank given by the other users.

FIG. 9K shows one embodiment of the WHO LIKES YOU area of the online dating software application, showing the user clicking “like” (heart symbol)

FIG. 9L shows one embodiment of the WHO LIKES YOU area of the online dating software application, showing the now-matched profile sliding up as it moves to the MATCHES area and the other profiles sliding up.

FIG. 9M shows one embodiment of the WHO LIKES YOU area of the online dating software application, showing the now-matched profile visible at the bottom of the MATCHES area.

FIG. 9N shows one embodiment of the MATCHES area of the online dating software application, displaying the profiles of other users that our current user has matched with, arranged in order of best rank given by the user.

FIG. 9P shows one embodiment of the MATCHES area of the online dating software application, showing the match Carly improving the rank of our user from 7 to 6.

FIG. 9Q shows one embodiment of the MATCHES area of the online dating software application, shows our user sliding Carly's profile up to rank 3 which is a rank that qualifies for a message to be open.

FIG. 9R shows one embodiment of the MATCHES area of the online dating software application, showing that due to the other user Carly has not positioning our user in rank that will open a message, a message is not opened.

FIG. 9S shows one embodiment of the MATCHES area of the online dating software application, displaying the profiles of other users that our current user has matched with, arranged in order of best rank given by the our user.

FIG. 9T shows one embodiment of the MATCHES area of the online dating software application, showing the match Carly changing the rank of our user from 7 to 3, and due to her having 3 open message ranks and both users now ranking each other in open message ranks, an alert shows that chat is now open.

FIG. 9U shows one embodiment of the MESSAGES area of the online dating software application, now showing Carly's message as open and accessible.

FIG. 10 is a block diagram of a computer system that may be programmed to implement the techniques described herein.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

As discussed above, there currently exists a need in the industry for a new and unique online dating system that offers more transparency between users, so that the decisions made on who to like, who to match with and who to message with is done with more knowledge of the other users' feelings towards the user, leading to higher quality interactions between the users. Disclosed hereafter is a novel online dating system and method based upon the principle of a transparent ranking system.

As used herein, the terms “like”, “liked” or “liking” will mean to show/shown/showing interest. The terms “match”, “matched” or “matching” will mean when users have agreed mutual interest between them.

When using the system, at some point either at registration or prompted by the system if the data is not already present, the user will be asked to declare a time by which they will check the app each day, and how long they need to respond to expressions of interest. The data is stored, called the app check time and response time.

The user registers in the traditional sense, answering questions and uploading images. But when uploading images, the user has to allocate that image to a specific image type e.g. face, full length, hobbies etc.

The user considers interacting with other users by using search results to find users they may have interest in. The system not only allows the user to see search results by a traditional filter based on user answers, but by selecting the image type that they would like to see their results in. For example, to see all face photos of other users, or to see all full-length photos of other users, or other image types that may be relevant to the system.

When the user interacts with other users by sending a like or expression of interest or other similar means, that like is not sent in the traditional form of a text message, but instead has to be sent either as audio (voice message) or video (video message) format.

Further to this, in one implementation, as well as sending the expression of interest and a voice/video message, the user also sends their perceived intentions towards the type of relationship with the other user, such as friendship, casual, serious etc or other suitable intention status.

After each like is sent by a user, that user must rank the other user in relation to the other users they have already liked or matched with. Each user's rank is unique and signifies the level of priority that the other user feels towards them. The rank given is displayed to the other user.

Users continually adjust the ranking of others user as they use the system, ranking other users a higher or lower priority as they like and match with more other users and change their priority of the people they want to communicate with.

Users use the transparent rank system to identify users with a higher chance of communication, by seeing the users who are showing a strong interest by showing a high like rank, and the matches who are showing a strong interest to communicate by showing a high match rank.

The system is live and fluid, providing real time feedback and allowing users to know their true position in the eyes of the other person at any given moment, by seeing their rank change in real time.

For example, a user may see another user is ranking them very highly, and although the user didn't initially rank this other user so highly, the fact that the other user is ranking them highly makes our user feel more attracted to them. So, our user increases the rank of that other user until they move each other into a position that opens a message.

When one user ranks another user in rank 1, or the top priority position according to the design of the system, the other user's app check time then comes into effect. When the app check time of the other user is reached, any rank 1 likes that user has received will be put on a countdown using the other user's response time to make the calculation for the countdown. During the countdown, that user who received the like then has the choice either to respond back to the like and create a match, or allow the like to expire, or to delete the like.

When the user goes to the area of the app called Who Likes Me, the user may again use a set of filters available such as answer filters or photo filters, to analyze the interest received in a more accurate manner to their preferences to find better people to return interest to and make a match.

Once matched, then again, they must rank that user match in relation to the other users they have already matched with. Each user's rank is unique and signifies the level of priority that the other user feels towards them. The rank given is displayed to the other user.

According to one implementation, after rankings have been established in this manner, then system only allows users to have a select number of open messages with other users at any one time, to reduce the negative effects of too many messages such as ghosting or poor communication. So, for example, the settings may allow 3 open messages at any one time, so in the matches area, rank positions 1, 2 and 3 will qualify to open a message.

Alternatively, instead of the system allowing the user to create more matches than the number of communication channels that user has chosen to have available, the system will stop all methods of new matches being created at the moment the new user reaches that total number of communication channels they have decided to have open (their choice of maximum matches), by removing the user from searches and offering users who have already received interest from that user a match request option rather than being able to directly create a new match. The user can then respond match request when they again have room in their matches area.

If the user makes a decision that they would like to only continue communication with one user (or more than one user if polyamorous) and do not want to consider to open any more communication channels with other users, then the user can activate the lockdown function, which will delete all communications with other users and stop any new communications being created. This lockdown status is shown to other users.

When chatting to other users, the user may also be indicating the intentions of the relationship to that user. That intention status is live and can be changed at any time.

When then meeting in real life, the users can continue to use the intentions status, so that if either user decides there is a change in their intentions towards the other user, then they may use the system to record that change of intentions which will notify the other user.

One a date or meeting has been arranged and completed, each user is then invited to provide a review of the meeting. But instead of a traditional dating system where reviews are written by each person, the review must be completed by the two (or more) users together, with the output being either a joint review that they have agreed on other or the inability to agree on a joint review. The ratio of agreed/not agreed reviews may be displayed to other users.

As well as the above-named features, other embodiments of the online dating system may also include the following:

The system may have a sliding functionality to change the rank between the users.

In one implementation, data from the system may be displayed to other users such as the number of matches or open messages, the users app check time and response time, the number of likes, the number of rank movements the user completes, the number of lockdowns, or any other data specific to the system.

The system may have a manual switch by where the user may stop the ability for other users to make matches with them by removing their profile from search and activating a match request function to users they have already shown interest to, thereby stopping the creation of new matches without the user confirming they still want to create a match.

The system may allow a like or match to take place based on what rank the user will accept. For example, if the user decides they will only accept a max rank 5, then the system will not allow a like or match to take place if the other user attempting to create the new like or match already has 5 or more likes sent to other users or matches created.

The system may only open a message between users when both users rank each other in positions that open a message. The system may not open a message when only one of the users opens a message.

The online dating system may restrict the number of other users a particular user can like or match with at any one time.

The number of matches or open messages available may be determined by the user, an algorithm, administrators of the online dating system or other users, or any other possible means by which a number can be generated, rather than decided by the user

The labels used to signify the rank of attractiveness or priority may not use ascending numbers and instead use things such as number in another order, letters , (a, b, c etc), words (“wifey position”, “lover positions”, other display information (stickers or emojis) for example, or any other means that may be suitable. This label may also be edited by the user.

The online dating system may allow a restricted amount of communication between users who have shown interest in each other or matched but who do not currently have an open message available.

The online dating system may also be used to match more than two or more users.

The online dating system may display information that shows the average time a user takes before they re-rank profiles and open messages from one user to another.

Users may be able to use the online dating system to rank attendees who have registered to use the online dating system at an in-person meeting or event. This may be done without the requirement to like or mutual match before ranking them, only requiring to rank the attendees.

Users may be able to rank other users in relation to other users without liking or matching them, by simply assigning them to a ranking list.

An area of the online dating system may be created as a Friendzone list for users to create a list of users they can make friendship with rather than dating.

The user may press “like”, “friendzone” or “not interested” on the full display of the users' profile, or in the search results, or in any of the graphical user interfaces displayed by the online dating system where those options may be made available.

The system may penalize behavior deemed as negative on the system, such as ghosting for example. The penalty may be served in various ways not limited to such things as a reduction in the allowed number of open messages,

The disclosed online dating system and method are unique when compared with other known processes and solutions in that it provides:
Functionality that requires users to rank their likes in order of priority in relation to their other likes they already have.
Functionality that displays the like rank given from one user to another.
Functionality that requires users to rank their matches in order of priority in relation to their other matches they already have.
Functionality that displays the match rank given from one user to another.
Functionality that notifies users when another user has moved them up or down in rank and displays the new rank to the user.
Functionality that allows a select number of open messages or matches for each user Functionality that shows how many matches or open messages a user has open at any one time.
Functionality that allows users to search by image type
Functionality that allows users to block new matches being created from interest already sent.
Functionality that requests

The disclosed online dating system and method are unique in that it is different from other known processes or solutions. More specifically, it forces users to rank their likes and matches in relation to their other likes and other matches. This means that users will spend more time evaluating profiles before deciding to like or match, as liking or matching profiles who are not competitive against their current likes or matches will be a waste of time.

It provides transparency between users on how they are ranked in relation to other users at each stage of the process of opening a message. That feedback will allow users to focus less on users who are ranking them low and instead focus on users who are ranking them high.

It provides a select number of open messages between matched users so users can focus more on the messages they currently have open, encouraging better connections and a more definitive end to the start and finish of communication.

The online dating system is live and fluid. It provides real-time feedback when users change the rank of the other user's profile up or down, providing continued real-time updates as to the priority the other users are placing them. This results in quicker feedback to users about their current attractiveness to other users and for the user to adjust their hopes accordingly.

The techniques described herein could help people with poor matching skills to find better matches, for example users who regularly “aim too high” or rank other users who don't find them attractive. They may find that other types of users who they had not considered previously are ranking them highly, so therefore reassess the people they rank themselves accordingly.

It provides transparency to all users as to how many open messages a particular user has open at any one time. This means users can better assess if a user is someone they want to interact with, as some users will not want to communicate with other users who have a high number of open messages (helping avoid “players”, people who communicate with a high amount of people).

Overall, the online dating system proposed provides a significant improvement over other online dating systems in the market and overcomes specific problems arising in the interaction of dating profiles. It does this through an inventive concept in the form of a transparent ranking online dating system with slide and rank functionality. It solves the problems by considering that the attraction felt by a user is not just based on that own users' feelings, but also the level of attraction that they receive from other users in relation to that other users' options. By factoring this into the system, it significantly increasing a user's efficiency to find the other users who have the highest desire to meet them as well as providing real-time updates when other users change their level of attractiveness towards them. This is extremely important in a market current valued at over $3 billion USD and over 270 million users.

The features and advantages described in this summary and the following detailed description are not all-inclusive. Many additional features and advantages will be apparent to one of ordinary skill in the art in view of the drawings and specifications.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The online dating application software system and method may, however, be embodied in many different forms and should not be construed as being limited to the embodiments set forth herein; rather, these embodiments are provided by way of illustration only and so that this disclosure will be thorough, complete, and fully convey understanding to those skilled in the art.

### Description of Implementations

Before explaining at least one embodiment of the presently disclosed and claimed inventive concepts in detail, it is to be understood that the presently disclosed and claimed inventive concepts are not limited in their application to the details of construction, experiments, exemplary data, and/or the arrangement of the components set forth in the following description or illustrated in the drawings. The presently disclosed and claimed inventive concepts are capable of other embodiments or of being practiced or carried out in various ways. Also, it is to be understood that the phraseology and terminology employed herein is for purpose of description and should not be regarded as limiting.

In the following detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, certain well-known features may not be described in detail in order to avoid unnecessarily complicating the instant disclosure.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherently present therein.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

The term “and combinations thereof” as used herein refers to all permutations or combinations of the listed items preceding the term. For example, “A, B, C, and combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. A person of ordinary skill in the art will understand that typically there is no limit on the number of items or terms in any combination, unless otherwise apparent from the context.

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

The use of the terms “at least one” and “one or more” will be understood to include one as well as any quantity more than one, including but not limited to each of, 2, 3, 4, 5, 10, 15, 20, 30, 40, 50, 100, and all integers and fractions, if applicable, therebetween. The terms “at least one” and “one or more” may extend up to 100 or 1000 or more, depending on the term to which it is attached; in addition, the quantities of 100/1000 are not to be considered limiting, as higher limits may also produce satisfactory results.

Further, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein qualifiers such as “about,” “approximately,” and “substantially” are intended to signify that the item being qualified is not limited to the exact value specified, but includes some slight variations or deviations therefrom, caused by measuring error, manufacturing tolerances, stress exerted on various parts, wear and tear, and combinations thereof, for example.

Software may include one or more computer readable instructions that when executed by one or more components cause the component to perform a specified function. It should be understood that algorithms or process instructions described herein may be stored on one or more non-transitory computer readable medium. Exemplary non-transitory computer readable medium may include random access memory, read only memory, flash memory, and/or the like. Such non-transitory computer readable mediums may be electrically based, optically based, and/or the like.

Circuitry, as used herein, may be analog and/or digital components, or one or more suitably programmed processors (e.g., microprocessors) and associated hardware and software, or hardwired logic. Also, “components” may perform one or more functions. The term “component,” may include hardware, such as a processor (e.g., microprocessor), an application specific integrated circuit (ASIC), field programmable gate array (FPGA), a combination of hardware and software, and/or the like. The term “processor” as used herein means a single processor or multiple processors working independently or together to collectively perform a task.

Additionally, it is to further be understood that the provider and receiver as described herein are not limited to human beings, and may comprise, an animal, a thing, a computer, a server, a website, a business entity, a human, a group of humans, a virtual computer, combinations thereof, and the like, for example.

Certain exemplary embodiments of the invention will now be described with reference to the drawings. In general, such embodiments relate to connection of at least two users in real-time, facilitating a human-to-human interaction between such users, while protecting privacy of each user.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present disclosure is to be considered as an exemplification of the invention and is not intended to limit the invention to the specific embodiments illustrated by the figures or descriptions below.

Where descriptions mention the ability to show a like, friendzone or not interested, in some embodiments this can be done directly from search results shown or by then viewing a more detailed view of the user profile. It should be considered that where options are only discussed from search results, the online dating system will provide the option to view the detailed profile and repeat the same option to indicate like, friendzone or not interested.

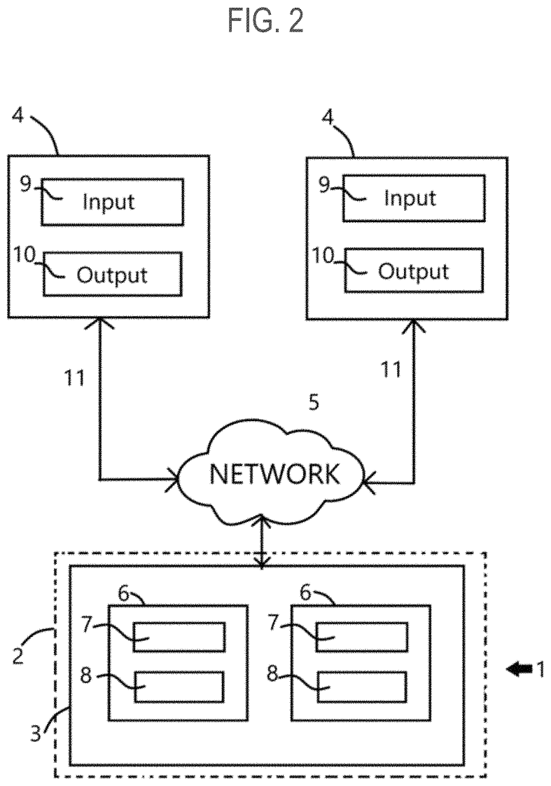

Referring to FIG. 2, the online dating system 1 may be a system or systems that are able to embody and/or execute the logic of the processes described herein. Logic embodied in the form of software instructions and/or firmware may be executed on appropriate hardware. For example, logic embodied in the form of software instructions or firmware may be executed on a dedicated system or systems, a distributed system, and/or the like. In some embodiments, logic may be implemented in a stand-alone environment operating on a single processor and/or logic may be implemented in a networked environment, such as a distributed system using multiple computers and/or processors.

Referring to FIG. 2, the online dating system 1 includes a management system 2. The management system 2 may include one or more processors 3 configured to communicate with two or more user systems 4 over a network 5. The one or more processors 3 may work together, or independently to execute processor executable code. Additionally, the management system 2 may include one or more memories 6 capable of storing processor executable code. In some embodiments, each element of the management system 2 may be partially or completely network-based or cloud-based, and may or may not be located in a single location.

The one or more processors 3 may be implemented as a single or plurality of processors working together, or independently, to execute the logic as described herein. Exemplary embodiments of the one or more processors 3 may include, but are not limited to, a digital signal processor (DSP), a central processing unit (CPU), a field programmable gate array (FPGA), a microprocessor, a multi-core processor, and/or combinations thereof, for example. The one or more processors may be capable of communicating via the network 5 or a separate network (e.g., analog, digital, optical, and/or the like) via one or more ports (e.g., physical or virtual ports) using a network protocol. The one or more processors 3 may be capable of reading and/or executing processor executable code and/or capable of creating, manipulating, retrieving, altering, and/or storing data structure(s) into one or more memories (e.g., memory 6).

In some embodiments, at least a portion of the management system 2 may be network-based, cloud based, and any variations thereof, and may include the provision of configurable computational resources on demand via interfacing with a computer and/or computer network, with software and/or data at least partially located on the computer and/or computer network, by pooling processing power of two or more networked processors.

The management system 2 may read and/or execute processor executable code and/or create, manipulate, retrieve, alter and/or store data structures into one or more memories 6. The one or more memories 6 may store processor executable code. Additionally, the one or more memories 6 may be implemented as a conventional nontransitory memory, such as, for example, random access memory (RAM), a CD-ROM, a hard drive, a solid-state drive, a flash drive, a memory card, a DVD-ROM, a floppy disk, an optical drive, combinations thereof, and/or the like, for example.

In some embodiments, the one or more memories 6 may be located in the same physical location. Alternatively, one or more memories 6 may be located in a different location as the management system 2 and communicating via a network, such as the network 5. Additionally, one or more of the memories 6 may be implemented as a “cloud memory” (i.e., one or more memories may be partially or completely based on or accessed using a network, such as network 5, for example).

The one or more memories 6 may store processor executable code and/or information comprising one or more databases 7 and program logic 8. In some embodiments, the processor executable code may be stored as a data structure, such as a part of database and/or data table, for example. In some embodiments, one of the databases 7 may be a user database storing identifying characteristics retrieved and/or determined from one or more users for the online dating system 10. In some embodiments, one of the databases 7 may be a user communication database storing one or more communications received from the user system(s) 4 (e.g., message).

In some embodiments, the program logic 8 of the management system 2 may include an application programming interfaces (API) 11 (e.g., representational state transfer (Restful Service) API) to communicate with the user system 4. It should be noted that the management system 2 may communicate with the user system 4 via other methods including, but not limited to, simple object access protocol (SOAP), direct communication, and/or the like.

The management system 2 may be capable of interfacing and/or communicating with the two or more user systems 4 via the network 5. The network 5 may be almost any type of network. For example, the network 5 may interface by optical and/or electronic interfaces, and/or may use a plurality of network topographies and/or protocols including, but not limited to, Ethernet, TCP/IP, circuit switched paths, and/or combinations thereof.

For example, in some embodiments, the network 5 may be implemented as the World Wide Web (or Internet), a local area network (LAN), a wide area network (WAN), a metropolitan network, a wireless network, a cellular network, a Global System for Mobile Communications (GSM) network, a code division multiple access (CDMA) network, a 3G network, a 4G network, a satellite network, a radio network, an optical network, a cable network, a public switched telephone network, an Ethernet network, combinations thereof, and/or the like. Additionally, the network 5 may use a variety of network protocols to permit bi-directional interface and/or communication of data and/or information. It is conceivable that in the near future, embodiments of the present disclosure may use more advanced networking topologies.

In some embodiments, the network 5 may be the Internet and/or other network. For example, if the network 5 is the Internet, a primary user interface of the user system 4 may be delivered through a series of web pages. It should be noted that the primary user interface of the user system 4 may be replaced by another type of interface, such as, for example, a Windows-based application.

The user system 4 may be implemented as a smartphone, a tablet, a laptop computer, a personal computer, a desktop computer, a computer terminal, a computer workstation, an e-book reader, a wireless network-capable handheld device, a personal digital assistant, a kiosk, a gaming system, and/or the like. Similar to the management system 2, the user system 4 may be provided with one or more processors, one or more nontransitory processor readable medium, an input device, and an output device. The processor, the one or more non-transitory processor readable medium, the input device, and the output device of the user system 4 may be implemented similarly to or the same as the processor 3.

The user system 4 may include one or more input devices 9, and one or more output devices 10. The one or more input devices 9 may be capable of receiving information directly from a user, processor, and/or environment, and transmit such information to the one or more processors 3 and/or the network 5. The one or more input devices 9 may include, but are not limited to, implementation as a keyboard, touchscreen, mouse, trackball, microphone, fingerprint reader, infrared port, cell phone, PDA, controller, network interface, speech recognition, gesture recognition, eye tracking, brain-computer interface, combinations thereof, and/or the like.

The one or more output devices 10 may be capable of outputting information in a form perceivable by a user and/or processor(s). In some embodiments, the one or more output devices 10 may be configured to output information automatically (i.e., without human intervention). The one or more output devices 10 may include, but are not limited to, implementation as a computer monitor, a screen, a touchscreen, a speaker, a website, a television set, an augmented reality system, a smart phone, a PDA, a cell phone, a fax machine, a printer, a laptop computer, an optical head-mounted display (OHMD), combinations thereof, and/or the like.

In some embodiments, the user system 4 may store processor executable instructions or a software application. For example, the user system 4 may include a web browser and/or a native software application running on the user system 4 and configured to communicate with the management system 2 over the network 5. The software application on the user system 4 may be configured to access a website and/or communicate information and/or data with the management system 2 over the network 5.

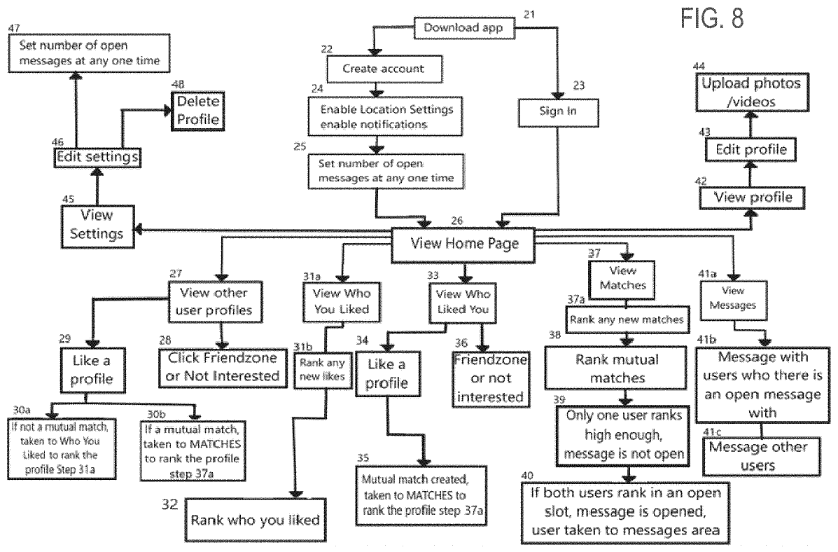

FIG. 8 illustrates a flow chat of a preferred embodiment of a online dating software application for the online dating system 1 for use on the user system 4 shown in FIG. 1001. The online dating software application may be downloaded onto the one or more user systems 4 as shown in step 21. The online dating software application may provide a loginpage for the user on the user system 4.

The online dating software application may provide ability for storage and management of a user account. To that end, a collection of data associated with a particular user of the online dating software application may be stored in the management system 2 in the user account. In some embodiments, at least a portion of the data associated with a user of the online dating software application may be stored on the user system 4 associated with that user. Each user account may include, but is not limited to, username, password, history of interactions with the online dating software application, setting preferences, for example.

The user may be given the option to create an account as in step 22 or sign-in to an already created account as in step 23. The user may be given the option to enable location setting and/or enable notifications via the user system 4 as in step 24. Location settings of the user system 4 may allow the user system 4 to provide the geographic location of the user system 4 to the management system 2 for use in the online dating software application as described in further detail herein. For example, in some embodiments, the user may allow the management system 2 access to location services of the user system 4. The user system 4 may relay positional data (e.g., GPS data) to the management system 2 via the API 11. The positional data may be recorded and/or stored in the one or more database 7 of the management system 2.

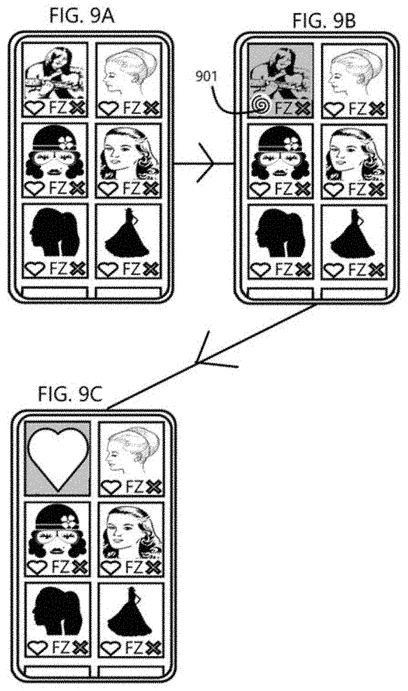

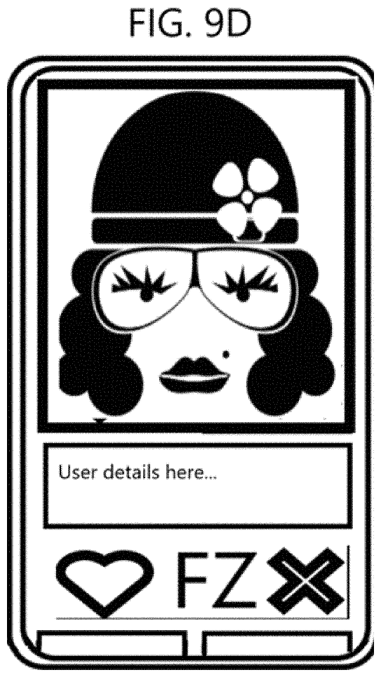

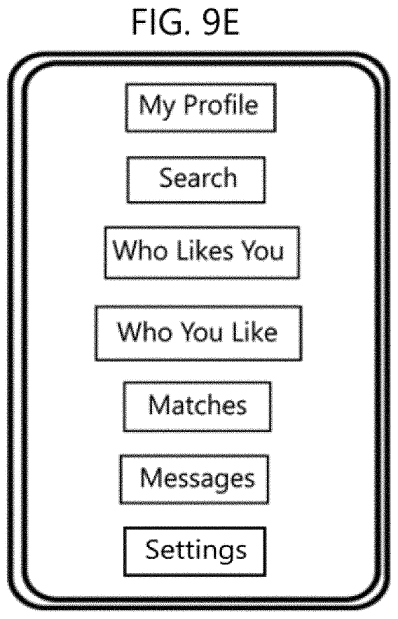

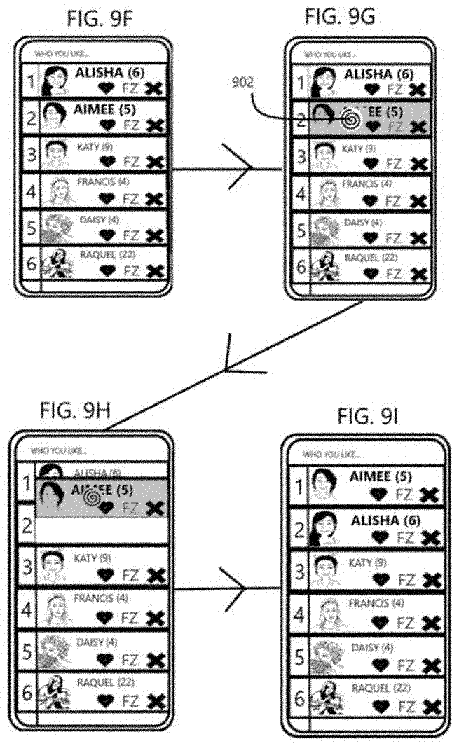

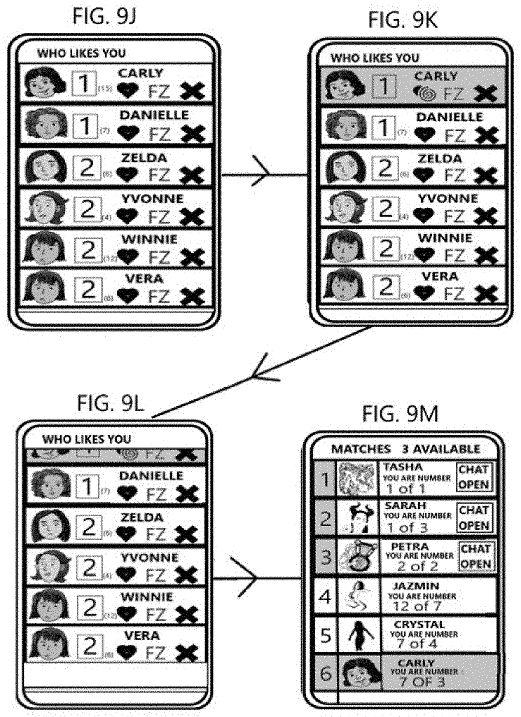

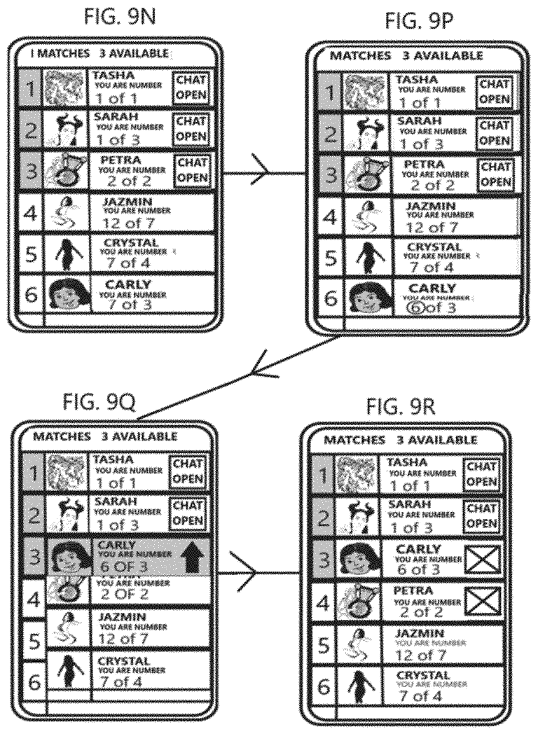

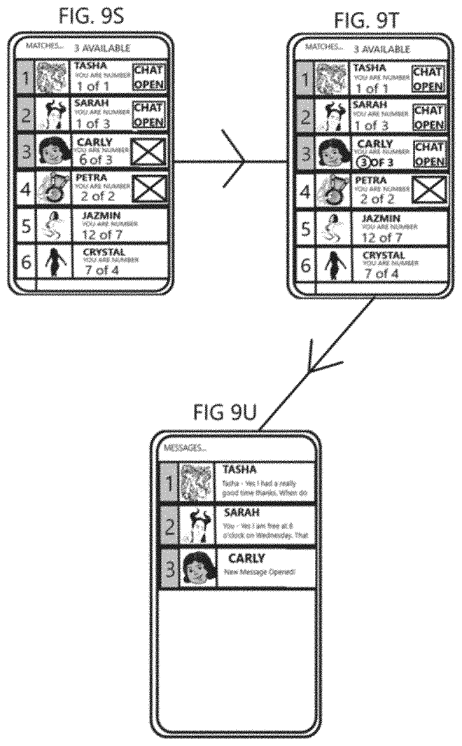

In one embodiment of the online dating system during use of the online dating software application on the user system 4, the online dating software application may provide the user with a homepage step 26 that allows the user to go to one of seven parts of the interface—PROFILE, SEARCH, WHO YOU LIKE, WHO LIKES YOU, MATCHES, MESSAGES, and SETTINGS an example screen shot shown in FIG. 9E.

In one embodiment of the online dating system during use of the online dating software application on the user system 4, the online dating software application may provide the user with the ability to browse profiles as shown in step 27. For example, the user may be provided by the online dating software application a listing of user profiles within proximity to the user to their user system 4 and show in FIG. 9A. The user may engage with the functionality of the application and browse through the profiles assessing the attractiveness of them. Viewing of the profile may be provided prior to any interaction with the potential online dating. Referring to FIG. 9A in some embodiments, the online dating software application may provide the user the ability to view partial information on a profile and the ability to like, friendzone or not interested before clicking on the profile.

In step 29, In some embodiments, the online dating software application may provide the user with the ability to “like” a profile. When this happens the other users profile may be moved from this area of the system to another area of the system, shown in FIG. 9A, 9B, and 9C. The area the profile moves on is dependant if there is a mutual match or not.

From step 29, if the profile shown attraction to (“liked”) is not a mutual match 30a, the other user profile may be moved to the area WHO YOU LIKE. In some embodiments, the online dating software application may then take the user to step 31a and 31b to rank the other user profile. An embodiment of functionality of this area is discussed below.

Also, from step 29, if the profile shown attraction to (“liked”) is a mutual match 30b, the other user profile may be move to the MATCHES area to view matches 37 and step 37a to rank the newly matched user profile in the MATCHES area. An embodiment of functionality of this area is discussed in detail below.

In step 31a, in one embodiment of the online dating system during use of the online dating software application on the user system 4, the online dating software application may provide the user with the ability to browses the profile who they have shown attraction to (“liked”). If a new like is being brought to the area from 30a, the online dating system may force the user to rank this “liked” profile first step 31b before allowing the user to use the functionality to change the ranks of who they liked as in step 32. The functionality may allow users to slide their likes up and down, ranking them in priority of order, with 1 being the highest priority at the top and ascending numbers going down signifying lower priority, 2, 3, 4, 5 etc. The user may then rank who they, by sliding the profiles up and down as shown in FIG. 9F, 9G, 9H and 9I. When this is done, a notification to the other user about the movement in rank is sent to the other user.

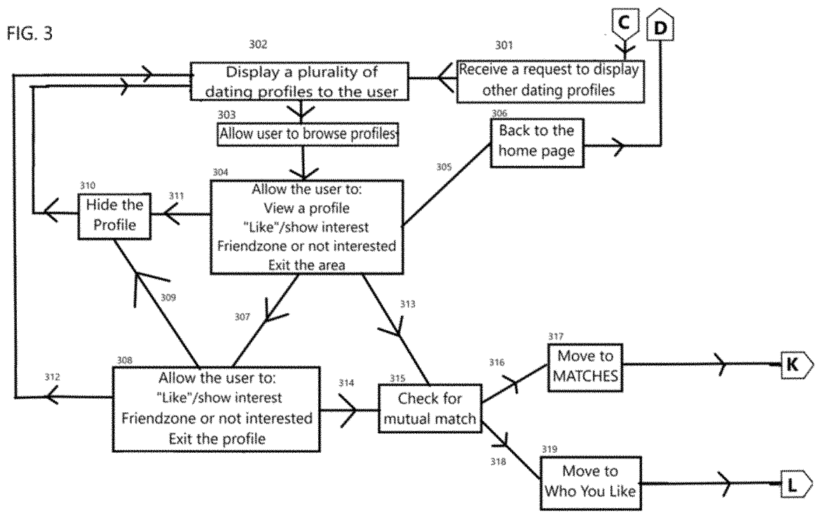

In step 33, in one embodiment of the online dating system during use of the online dating software application on the user system 4, the online dating software application may provide the user with the ability to browse user profiles who likes them in the section WHO LIKES YOU, which shows the user the other users who have have “liked” their profile shown in FIG. 9J. This area may not have sliding functionality. Instead, the profiles may sorted based on the ranks received from other people. So, other users who have ranked the user highly with the number 1 may be at the top, then users who have ranked our user with lesser priority ranks such as 2, 3, 4, 5 etc. may be displayed in ascending order going down the table also shown in FIG. 3A. The user may have many people who have ranked them as 1, or the user may have no rank 1 and instead lower numbers. This will be dependent on the attractiveness rank given by the other user in relation to the other users that that other user has “liked”, as shown in FIG. 9J.

In step 34, in some embodiments, the online dating software application may provide the user the ability to like a profile that has already “liked” them to create a mutual match step 35 as shown in FIG. 9J, 9K, 9I and 9M. The profile may then move to the Matches area for the user view the current matches 37 and rank the new mutual match 37a. The user may then be able to adjust the rank of all the matches step 38 with the aim of ranking another user in a rank that opens a message whilst the other user also too ranks them in a position that opens a message step 40. The functionality of the online dating system on these steps is discussed below.

In step 37, in one embodiment of the online dating system during use of the online dating software application on the user system 4, the user views mutual matches in the MATCHES area. The MATCHES is a ranking table, numbered from 1 to an unlimited number. The MATCHES area has functionality which allows the user to slide their matches up and down, ranking them in chosen priority of order, with 1 being the highest priority at the top and ascending numbers going down signifying lower priority, 2, 3, 4, 5 etc. The user ranks the profiles they matched with according to the attractiveness that they rank a user profile in relation to their other profiles have already matched with step 38 and shown in FIG. 9N, 9P, 9Q and 9R. When the particular user changes the rank of another user, a notification may be sent to the other user about the change in rank.

From step 38, in one embodiment of the online dating system during use of the online dating software application on the user system 4, the user changes the ranks of the matches step 38, with the aim of ranking the other user in a position that opens at message whilst at the same time the other user also ranks the particular user in a position that opens a message. When the particular user ranks the other user in a position to open a message, but the other user has not ranked the user in their own positions for an open message, a message may not opened as shown in FIG. 9R.

From step, in one embodiment of the online dating system during use of the online dating software application on the user system 4, with the aim of ranking the other user in a position that opens at message whilst at the same time the other user also ranks the particular user in a position that opens a message, both users rank each other in a position that opens a message step 40 and shown in FIG. 9T. A notification is received by our user that the other user has changed their position to an open message, and the user is taken to the messages area to view the open message 41a shown in FIG. 9U.

In step 41a, in one embodiment of the online dating system during use of the online dating software application the user may request to view the open messages. The open messages are only shown with users who both rank each other in high enough rank positions at the same time. The user may also then open any of the messages step 41b and interact with the other user step 41c.

In step 42, in one embodiment of the online dating system during use of the online dating software application on the user system 4, the user may view their profile 42, edit their profile 43 and upload photos and videos 44.

In step 45, in one embodiment of the online dating system during use of the online dating software application on the user system 4, the user may view the settings 45, edit the settings 46, change the number of open messages they have at any one time 47 or delete their profile 48.

In some embodiments, the online dating software application may provide different levels of access (e.g., premium access, basic access) to users of the user systems 4. For example, a first user may be provided with premium access providing additional features of use. To that end, the online dating software application may allow different levels of security or functionality based on compensation provided by the user.

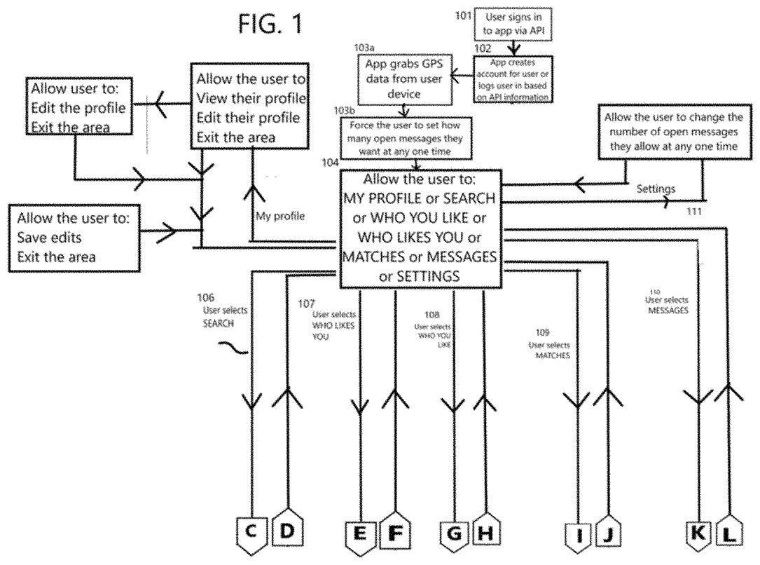

FIG. 1 illustrates a flow chart of the management system 2 of the online dating system 1. The management system 2 generally regulates interactions between two or more user systems 4.

In a step 101, the user using the user system 4 may sign into the online dating software application on the management system 2 via API 11. The management system 2 may create and/or store user accounts for each user based on information and data provided by the user system 4 via the API 11 as shown in step 102. The online dating software application may force the user to select how many positions they want to qualify to open a message with other users step 103a and then receive GPS data from the user systems 4 as shown in step 103b. The homepage may then as in step 104.

At step 104, whilst displaying the homepage. the management system 2 may receive a request from the user to display the SEARCH area as in 106, following path C to move to FIG. 3 and step 301 to receive a request to display other dating profiles and then step 302 to display a plurality of other dating profiles.

The management system 2 may allow the user the browse the profiles step 303. The management system 2 may then give the user functionality to be able to indicate a like, friendzone or not interested to another user while browsing without entering the profile step 304 as shown in FIG. 9A.

From step 304 the management system 2 may receive a request from the user to leave the area 305 and the management system 2 will take the user back to the homepage 306.

At step 304, the management system 2 may receive a request from the user system 4 to see a more detailed view of the profile as step 307, they can send a request to the management system 2 via the user system 4 to display a more detailed view of the profile step 308, and the management system 2 via the user interface may present to the user a more detailed view of the user profile shown in 9D, again giving the user the option to indicate a like, friendzone or not interested to the other profile.

At step 304, the management system 2 may receive a request from the user system 4 to indicate friendzone or not interested to the other profile 309, which may hide the profile of the user as step 310. This may also be similar to the process as step 311 if the user selects friendzone or not interested directly from the search results at step 304, this may also hide the other user profile.

At step 308, the management system 2 may receive input from the user system 4 that the user wants to exit the profile step 312, so the management system 2 may take the user back to step 302, displaying a plurality of other user dating profiles to the user on the user system 4.

From step 304 the management system 2 may receive from the user system 4 a request indicate a “like” on another user profile step 313. This step may also be similar when taking step 314 viewing a indicating a “like” on the other user profile on detailed view of the profile step 308. When this occurs, the management system 2 may check with the database to see if the other user has already “liked” this other user 315.

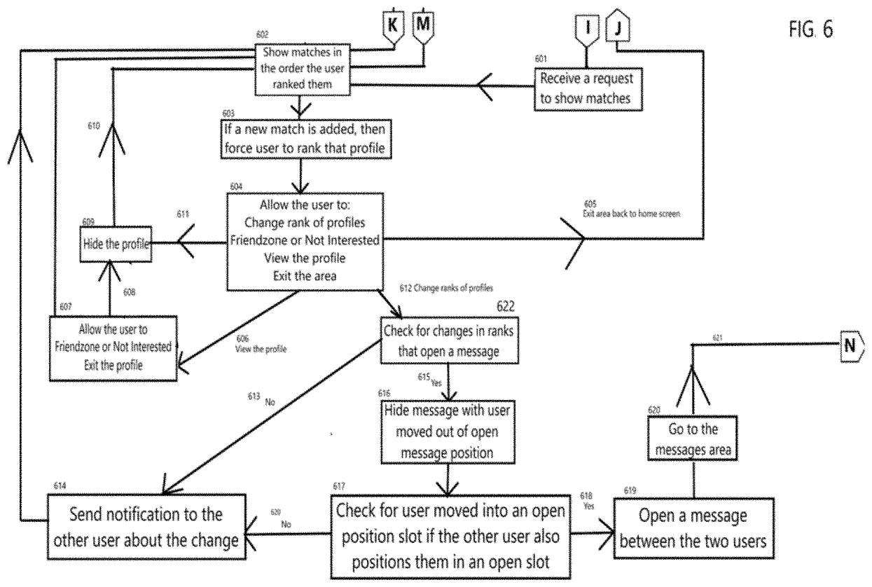

From step 315, if the management system 2 finds a match already exists with the user 316, then the other user profile is marked as a mutual match and moved to the MATCHES area step 317, following the process using K to FIG. 6. This process is detailed later in the document.

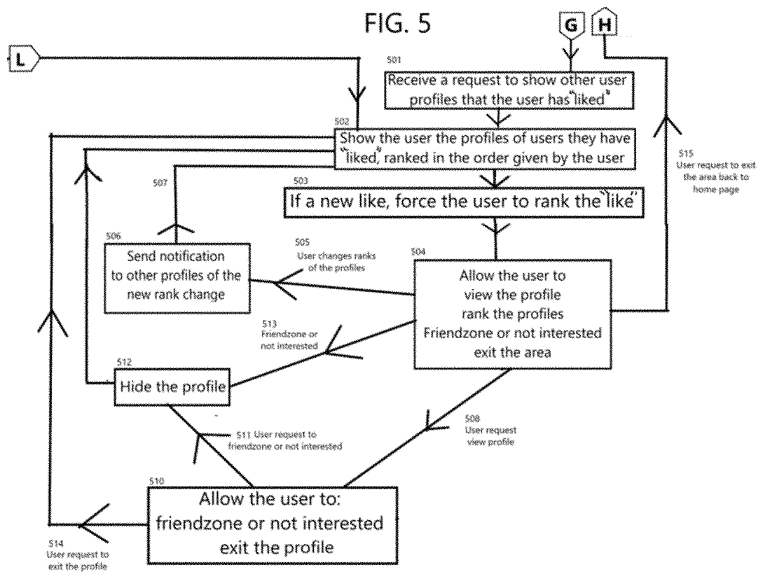

From step 315, if the management system 2 finds a match does not exist with the user step 316, then the other user profile is marked as a user who the user “liked” step 318, and the management system 2 moves the other user profile to the Who You Like area, following the process via L to the Who You Like area FIG. 5 to continue the process for the user. This process is detailed below.

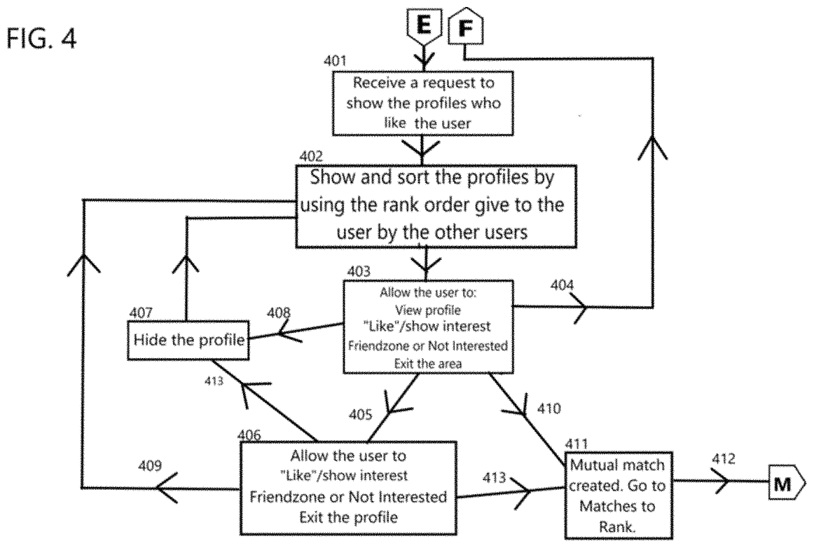

From FIG. 1 step 104 the management system 2 may receive a request to show the profiles of who like the user following step 107 via E to FIG. 4 as step 401, the management system 2 may display to the user on the user system 4 a list of the profiles who likes the user sorting the order by the rank given by the other user step 402. From step 402 the management system 2 allows the user to view a profile, like, indicate friendzone or not interested in a profile, or exit the area as shown in step 403 and FIG. 9J.

From step 403, the management system 2 may receive a request to leave the area 404. and the management system 2 will take the user back to the homepage shown on the FIG. 4 as the connection F continuing back to FIG. 1.

From step 403, the management system 2 may receive a request from the user system 4 to see a more detailed view of the profile step 405, so the management system 2 may present on the user interface a more detailed view of the user profile, again giving the user the option to indicate a like, friendzone or not interested to the other profile step 406.

From step 406, the management system 2 may receive a request from the user using the user system 4 to indicate friendzone or not interested to the other profile step 413, which may hide the profile of the user as step 407. This may also be similar to the process as from step 403 if the user selects friendzone or not interested directly from the search results step 408, this may also hide the other user profile.

From step 406, the management system 2 may receive a request from the user that the user wants to exit the profile step 409, so the management system 2 may take the user back to step 402, displaying a plurality of other user dating profiles to the user that the user has “liked” sorted by the rank given by the other users

From step 403 the management system 2 may receive a request to “like” the other profile as step 410, creating a mutual match step 410 and moving that profile to the MATCHES area step 411. The management system will then follow the process outlined in the MATCHES area, shown in this diagram step 413 via M to FIG. 6. This process may be similar when the user is looking at the detailed other user profile 406 and liking the profile 413, which also created a mutual match and moving the profile to the matches area step 411.

From FIG. 1 step 104 the management system 2 receives a request from the user device to display profiles the user has “liked” step 108 following the process via G to FIG. 1 and step 501. The management system 2 may then display the user profiles on the user system 4 step 502.

As shown at step 502 pathway L, if the management system 2 is moving a newly “liked” profile to this part of the interface from path L, the management system 2 may force the user to rank the newly “liked” user step 503 before allowing the user to engage with further functionality shown in 504.

From step 504, the management system 2 may give the user using the user system 4 the option to view the profiles, rank the profiles, indicate friendzone or not interested, or exit the area.

From step 504, the management system 2 may receive a request to change ranks of the profiles step 505. The information is received by the management system 2 and processed, and the management system 2 may send out a notification to the other users on their user systems 4 whose rank has changed 506. The management system may then follow step 507 to take the user back to show the renewed ranking list of who the user “liked” as in step 502.

From step 504 where the management system 2 may present to the user by way of the user system 4 the option to view the profiles, rank the profiles, indicate friendzone or not interested, or exit the area, the management system 2 receives a request from the user to view another user profile from the user device as step 508, the management system shows the user the detailed profile of the other user step 510.

From step 510 the management system 2 may receive a request from the user using the user system 4 to indicate friendzone or not interested on the profile step 511, the user management will hide the profile as step 512. This may be similar to the same process if the user indicates friendzone or not interested directly in the search results presented in 502 without the user requesting a detailed view of the profile as step 502.

From step 510, the management system 2 may receive a request from the user to exit the profile step 514 the management system 2 will take the user to step 502 and show the user on the user system 4 the profiles who the user likes, ranked in the order given by the user.

From step 504, the management system 2 may receive a request from the user to exit the area 515, the management system 2 may then take the user back to the homepage linking back to FIG. 1 via H and display the “liked” options 104 on the user system 4.

From FIG. 1 step 104 the user management system 2 may receive a request from the user device 4 to display MATCHES step 109 via I moving to FIG. 6 and step 601. The management system 2 may then display the user matches using user system 4 step 602.

At FIG. 6 step 602 the management may display the new matches created from the SEARCH via K from FIG. 3 or WHO LIKES YOU via M from FIG. 4. If so the management system 2 may force the user to rank the new matches step 603 before allowing the user to move to step 604.

At step 604, the management system 2 may give the user via the user system 4 the option to view the profiles, rank the profiles, indicate friendzone or not interested, or exit the area.

From step 604, the management system 2 may receive a request to leave the area 605 so the management system 2 may take the user back to the “liked” via F to FIG. 1 and display on the user system 4 the “liked” step 104.

From step 604, the management system 2 may receive a request from the user system 4 to see a more detailed view of the profile 606, so the management system 2 may then present on the user system 4 a more detailed view of the user profile 607, giving the user the option to indicate a like, friendzone or not interested to the other profile.

As step 607, the management system 2 may receive a request from the user system 4 to indicate friendzone or not interested to the other profile step 608, which may at step 609 hide the profile of the other user. This may also be similar to the process as step 611 when the management system 2 may receive a request from the user system 4 to friendzone or not interested directly from the search results without having to request to see the detailed view of the profile 604. The profile is hidden and the user may then be taken back to a list of the matches shown in the rank order given by the user steps 610 and 602.

From step 604 the management may receive a request to change the ranks of some of the profiles 612. The management system 2 may then check if any of the rank changes have taken place in users ranked in positions have messages open step 622. If the check results in a negative answer/no step 613 then the management system 2 may send a notification to the users whose rank changed step 614 and then back to step 602 showing the profiles of the matched users in the order as decided by the user.

From step 612, The management system 2 may then check if any of the rank changes have taken place in users ranked in positions that have messages open. If the answer is positive/yes step 615 then the management system 2 may hide the message if a user has been moved out of a position that qualifies for an open message 616. The management system 2 may then check then if the other user who has been moved into an open message position is also ranking our particular user in an open message position 617.

From step 617, the management system 2 may check that the user who has been moved into an open message position is also ranking our user in an open message position 617 and if the answer is no step 620, then the management system 2 may not open a message, and then send a notification to the other user that a position change has taken place, and then revert back to step 602 showing the profiles of the matched users in the order as decided by the user.

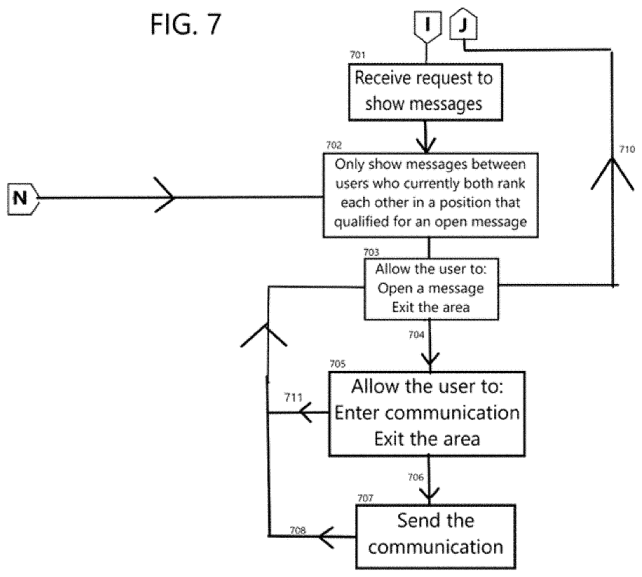

From step 617, the management system 2 may check that the user who has been moved into an open message position is also ranking our user in an open message position 617 and the answer is yes step 618, then the management system 2 may open a message between the two users 619 and take the user to the MESSAGES AREA step 620 and 621 via N moving to FIG. 7.

From FIG. 1 step 104 the management system 2 may receive a request from the user device to display MESSAGES step 110 via I to FIG. K and step 701. The management system 2 may then display to the user using the user system 4 the messages that currently qualify for being open as both users currently rank each other in positions that qualify for a message to be open 702. Also at step 702, if any new messages have been opened from the MATCHES area, the management system will bring the user to this step.

At step 702 seeing the open messages available, the management system 2 may allow the user to open a message or exit the area 703.

At step 703 the management system 2 may receive a request from the user to go back to the “liked” step 710. The management system 2 may then take the user back via J to FIG. 1 to show the homepage step 104.

At 703 the management system 2 may receive a request from the user using the user system 4 to open a message 704, the management system 2 on receipt of the request may then present to the user via the user system 4 functionality that may allow the user to communicate with the other user, such as text, audio, voice call, video call, send messages and videos, for example step 705.

From step 705, the management system 2 may then allow the user using the user system 4 to input communication 706 and the management system 2 may then send the communication to the other user 707. The user may then request to go back to the messages area 708 and the system may take the user back to step 703. Similarly, the user may also be taken back to step 703 via 711 without having entered or requested the system to send communication.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention.

### Additional Details/Features

### Block New Matches

One problem in traditional systems is too many communication channels open.

As mentioned above, to open communication channels, users send out many “likes”, and then when those other users “like” back, a communication channel is opened between the two to begin discussion.

Often what happens, is that the current user will already have a full amount of communication channels (i.e. messages) that they can deal with already open, but then the other users, who the current user liked in the past and those likes were pending responses, will then “like back”, creating new mutual interest and opening new communication channels.

The result is that the current user now has communication channels open which they are unable to manage or respond to in a normal and fair timeframe, which leads to inefficiency in the system and poor user experiences.

The solution is to have a method that allows the current user to block any new matches being made even though they have “likes” that have been sent out to other users, and from a response by the other users, could in the future open new, unwanted communication channels.

This is done by implementing a new function that can be switched on by the user or the system,

When switched on, any “likes” the current user have sent to other people, will be stopped from the usual response by the other user to be able to make a “like” and mutual match,

Instead, the other user, instead will see a different option and instead of making a “like” and mutual match, instead the other user sees the option to send a “match request”.

When the other user sends a match request, the current user will be able to see that match request and decide when they choose to accept that match request to open a new communication channel.

By having this in place, users of the service can control the number of communication channels they have open, leading to more efficient use of the app, better experiences for the users and better overall results.

### Lockdown

One problem in traditional systems that has not been solved is where a user desires to restrict their communication to just one user (if they enjoy monogamous relationships) or to a few selected users (if they enjoy polygamous relationships).

By not offering such a method, the user, although already content and communicating with a select person or people, the user has no way to close all other communication channels and stop new communication channels being opened.

Therefore, this invention relations to what could be considered an “Exclusive” function, or “Lockdown” function, where the user is given the ability to restrict their communication without leaving the app.

With a press of a button, the users will be shown an area to select the person or people that they would like to go exclusive or lockdown with.

One the button is pressed, the system will remove all communication channels and also stop any other communication channels being created. An example of this would be:
Delete all other open communication channels (matches)
Delete all likes sent out
Delete all likes received
Remove the user from all search results
Block any other methods of communication that the user could be exposed to, such as favourites lists, or other ways not mentioned.

By having this functionality, the app will perform better and retain its users, whilst also not forcing them to leave the app if they want to be exclusive.

### App Check Time and Response Time

One problem in traditional systems there is a lack of a method, system or process for users indicate to other users when they will check the app for activity and respond to any expressions of interest, messages or other such features in a dating app.

Therefore this invention is the creation of a method/system/process for users to input data into the dating system. That data declares when the user intends to log in and check and possibly respond to expressions of interest, messages or other similar features of a dating app.

In some embodiments of this method/system/process, the time is fixed. This could be called an App Check Time. The method/system/process could generate an alarm to warn the user that it is App Check Time, and the user has to log in.

In other embodiments of this method/system/process, the time may not be a fixed time but instead could be a time range. This could be called an App Check Schedule. The user may have one period of time e.g. 6 pm to 9 pm or the user may set more than one schedule e.g. 10 am to 10.30 am and 6 pm to 9 pm.

One a user has set an App Check Time or an App Check Schedule, that App Check Time or App Check Schedule will be made publicly visible on their profile to other users of the system.

By being able to submit an App Check Time or an App Check Schedule and then display it to other users, users are contributing to more efficient communication between all users on the app, and therefore better response rates between users.

When users can see the App Check Time or the App Schedule Time of other users, they can make better choices about who to show interest too first, based on the knowledge of who will possibly respond to interest sooner rather than later based on the App Check Time or the App Check Schedule the other user has declared on their profile.

Further to this, in some iterations of this invention, the App Check Time and the App Check Schedule it may be combined with some features such as a App Check Login report, which is shown to other users to publicly display if the user did or did not check in as they said they would. This again adds further to the efficiency of the system, allowing users to make better decisions on who to show interest to or send a message to first.

Further iterations may also make use of some things such as a timer/countdown, where a countdown will start on some or all of the interested received at the App Check Time. Then the user can either respond to the interest received or allow that interest received to “time out”.

Similarly, further iterations may also make use of some things such as a timer/countdown, where a countdown if interested is received during the App Check Schedule. Then the user can either respond to the interest received or allow that interest received to “time out” during the schedule.

By adhering responsibility to the App Check Time and the App Check Schedule, the user is committing to using the dating service regularly and contributing towards the greater goal of an efficient system between users.

### Timers

One problem in traditional systems is achieving a satisfactory response rate for responding to interest shown from one user to another.

Most apps, when users show interest to one another, allow the shown interest (a “like”) to sit in the other user's device, either waiting to be attended to or often never responded to.

Some apps have their own hard coded functionality (it cannot be adjusted by the user), which will expire the interest shown/the like after a set amount of time, say 24 hours, but no system so far has been shown to offer each individual user the ability to set their own individual personal response time, which is a huge oversight in the efficiency of ensuring that users can respond back in a time that is appropriate to them.

Individual response times vary from human to human, often due to the many complications of personal circumstances such as work commitments, family commitments or simply the level of desire to use a dating application.

Therefore, this invention is for allowing such functionality, where each user is given the ability to set their own personal time in which they will respond to interest received/a like given to them.

We call it the Like Response Time.

The invention allows each user to set their own Like Response Time in their settings on the app.

That data is stored in the database, and when that user receives a like from another user, the like received is put on a timer. That timer will start at the time set according to the value submitted by the receiving user for their own Like Response Time, and countdown from the Like Response Time to zero.

For example, if the Like Response Time set is 1 hour, then the timer will start on 1 hour, and count down 59 minutes, 58 minutes etc in coordination with the actual time that is passing.

If the like is not responded to in that given time by liking back and creating mutual interest, then the received like will expire will no longer be able to be responded to.

The timer will be shown to both users, so the user who sent the like can see how long is left on the timer before the like must be responded to or expires, and similarly, the user who received the like can also see timer and the countdown of their own Like Response Time to know how long they must respond to the like or to allow the like to expire and lose its ability to be responded to.

In some embodiments of the above invention, the User Like Response Time may be combined with other features such as a restriction on the amount of likes users may send out or receive at any given time.

In some embodiments of the above invention, the User Like Response Time may be combined with other features such as a ranking table, which may allow the user to prepare a list of likes, that will send in priority order, with one like or a limited number of likes being sent or put on timer at any given time.

In some embodiments of the above invention, the User Like Response Time will be displayed visibly on the public user profile for other users to see, allowing other users to make better decisions about who to send interest to i.e. if the other user desires a quick response, then the other user will seek users who have User Like Response Times that are low.

In some embodiments of the above invention, the User Like Response Time will be identifiable using a search filter function, again allowing other users to make better decisions about who to send interest to i.e. if the other user desires a quick response, then the other user will seek users who have User Like Response Times that are low.

In some embodiments of the above invention, the User Like Response Time will be identifiable using a search filter function, again allowing other users to make better decisions about who to send interest to i.e. if the other user desires a quick response, then the other user will seek users who have User Like Response Times that are low.

### Maximum Matches

One problem in traditional systems is the inability for users to set the number of matches they would like to set as their maximum matches.

The problem lies in that while is choosing to accept interest received and getting responses from interest sent, the user may reach a number of communication channels that they are aware that they can manage sufficiently, for example 3 channels. However, in the meantime, after reaching that sufficient number of open communication channels, the user may then get positive responses from interest sent out.

With no control of being able to stop further communication channels open, the user is left in an unfortunate position by where they now have more communication channels open than they desire, but also with people who they have show attraction too.

This leaves the user in a difficult position of having to choose between those users, as without action their own efforts will be diluted and inefficient, and by taking action they have remove the ability to connect with another user when, in a more efficient system, that other user would have been put on hold until the current user had sufficient time, and possibly could have been a good connection.

Therefore there exists the need for a system/method/process by which the user can personalize the control of the number of open communication channels they have available.

This invention describes this.

In some embodiments of the invention, when using the dating service, the user is prompted to enter the number of communication channels/matches they are comfortable engaging with at any time, for example 3 channels/matches FIG. 1. The data is received and stored in the dating service system.

The user uses the dating system normally and when the maximum number of communication channels opens, the system stops new matches being made from interest sent to other users.

This is done in a method by which the other users are no longer are able to respond to interest received from the current user by returning interest and opening a communication channel, FIG. 2. Instead, the other user is given the option to send a “match request” to open a communication channel FIG. 3, which is where that other user is showing interest in return, but the opening of the communication channel is postponed until the current user has capability again to open it (they have less communication channels than their stated number of communication channels).

In some embodiments of the invention, the original user, in a situation where they have more than one match request, will also be able to view their match requests and make a decision about what match requests to accept first.

In some embodiments of the invention, the original user will also be removed from the search results of all other users. Although being in search results does not mean that new communication channels can be opened (as any interest sent from other users would cause the current user to receive interest, not to open a new communication channel) it would be prudent not to distract the current user with more interest received when they already have reached the maximum number of communication channels, and therefore it would be the goal of the system to encourage.

Further to this, in some embodiments of the system, users can be penalised by the system for poor response rates to their open communication channels, with that penalty being a reduction of the number of allowed communication channels for that user until good behaviour is sustained for a period of time set by the dating service.

Furthermore, in some embodiments of the system, the response time to messages before a penalty is created make be set by the dating service, the user choice, by an algorithm calculation, or any means by which the dating service feels is the best fit.

Here is an example of an embodiment of the system:
1. User A sets their maximum communication channels at 3 open communication channels.
2. User A uses the system, and soon, via sending and receiving interest, they now have 3 communication channels open with other users User B, User C and User D.
3. At this point, for the users who User A had already previously sent interest to but they had not yet responded, those users can no longer respond to interest which opens a communication channel, instead they have the option to send a “match request”.
4. User E sees the option to send a Match Request to User A, so sends a Match Request to User A.
5. In the meantime, User A is not enjoying conversation with User B. So User A deletes the communication channel with User B, and now has one communication channel free.
6. The system, before restoring User A back to the normal position and allowing other users that User A already sent interest to create new open communication channels without requests, the system asks User A to check their current match requests first and use one of those requests to fill the currently available open communication channel.
7. User A looks at their match requests and sees the Match Request from User B. User A accepts the match request from User B.
8. User A and User B are talking a lot and getting on very well.
9. User A still has the communication channels open with User C and User D but is taking a long time to respond.
10. The dating system currently has a rule that users must respond in 24 hours and consistent failure will result in communication channel deletion. Because User A many times failed to respond to User C and User D in 24 hours, the system deletes the communication channels for those users AND restricts User A to only 1 open communication channel at any one time for 1 week.
11. After 1 week, User A can now increase the number of open communication channels to 2 channels, but chooses not to because he is talking very good with User E.

### Audio or Video Message When Liking

One problem in traditional systems is the accuracy of assessing the positive connection between interest received from a user without opening a communication channel.

In most modern dating systems, when users use a dating service, they send and receive interest from other users, usually with an inability to send communication or the ability send a limited amount of communication until both users agree they want to open communication. When both parties agree there is mutual interest, a communication channel is opened and then those users can communicate freely by sending text messages, audio messages, images etc.

Where opportunity is allowed to send a limited amount of communication, that communication is limited to text format only, which as a medium of communication between daters is poor in terms of the sending users ability to convey personality and tone, as well as the receivers ability to understand the personality and tone.

The need for a better solution exists.

This invention outlines the method for users to be able to send an audio voice recording or a video recording when sending expressions of interest to other users.

Users will use the dating service normally, and send interest as normal. However, after the stage at which the user confirms sending interest, the interest is not immediately sent, and instead the user is given a further prompt to send either a voice message or a video message. The user makes the choice, records the audio or video message, and presses send. Now the interest is sent to the other user.

When the other user receives the interest, they can play back the audio or video message. They can use that message to make a better decision on if that person is a good match for them, aside from making judgements on just their voice alone.

### Search By Image

One problem in traditional systems is the accuracy of finding a positive connection from search results due to the number of different types of photos that users often post on dating profiles.

Some users like to look at the faces of other users, some users like to look at the full length photos of other users. Some users want to see photos of the other users with their family and friends, and some users want to see photos of the other users using participating in a hobby.

Therefore, there exists a requirement for users to be able to filter and see search results by the type of image they want to see. This invention is the creation of a system/method/process to satisfy that requirement.

When using the dating service, users will go to the gallery page to upload photographs. But instead of seeing the usual gallery page with a genetic same placeholder for multiple images, the area is set up differently.

The gallery area will have multiple single placeholders but with a description by the side of each one.

The descriptions will indicate to the user what type of photograph should be uploaded to that particular placeholder e.g. a face photo, a full length photo, a photo with their family or friends, a photo doing their hobby etc.

The user will then upload the relevant image into each placeholder based on the description. The photo will be checked by admin or by computer identification of images such as AWS Rekognition to ensure that the photo matches the description asked that it contain. Once the image has passed the check it will then be saved to the user's profile.

But the dating service through its processors and memory will store that image not only allocating it to that user's profile but also to what type of photo it is of that user.

So now, a user called User A is using the dating service, and he can see his search results. But search results by their design usually only show one image, and that image is usually the image that the profile owner has decided to be the first photo and therefore the one that will show up in the search results.

Now with the invention in place, when User A is looking at the search results, he does not see a mix of different types of photographs of the different users chosen by those other users to be their first profile photo and therefore the one used in the search results.

Instead, User A sees photographs all of one specific type, and has options on his search results to choose the different types of photos that he wants to see.

For example, User A is using the search page, and he can see Users B-K in the search results. Right now, User A has his search results phot choice option set on Faces, so all the photos he sees are of the faces photos uploaded by Users B, C, D, E, F, G, H, I, J and K.

However, User A decides that he would like to look at full length photos instead. He uses the photo choice option that is available on the page to select. He presses Full Length, and all the photos displaying for Users B, C, D, E, F, G, H, I, J and K that were previously their face photos are now the full-length photos for Users B, C, D, E, F, G, H, I, J and K.

### Filter Who Likes Me List

One problem in traditional systems is the accuracy of finding a positive connection from a list of interest received, when that list is viewable, and that list is large.

No system currently exists in the market where the current user can use filters to filter the list of users who have sent interest, so that the current user may find better connections from that list. This document describes such an invention.

The user uses the system as normal, sending and receiving interest. When the user receives interest, that interest is stored in the Who Likes Me list.

When the user goes to the Who Likes Me list, they are presented with a list of the users who have sent interest. The user is now given the option of a filter button.

When the user presses the filter button, the user is able to filter the list of Who Likes Me by the various factors predetermined by the data input that has been created on the app e.g. height, age, hair colour etc.

By using the filter, the user is then able to filter the list of Who Likes Me and find better chances of potential mutual interest in a more efficient manner.

### Transparent Data

One problem in traditional systems is the accuracy of finding a positive connection from a list of interest received because particular sets of data are not being shared between users.

Although controversial, within a dating system, the sharing of usage information between all users would make the system more transparent, ultimately encouraging more positive behaviour, and making the interactions between users more efficient.

Therefore, this invention describes a method by which usage data of the app is shared publicly on user profiles.

The data shared would include but not limited to:
The number of likes that user current has sent out;
The number of likes that the user has received;
The number of matches that user currently has;
The user's response time to messages;
The user's number of positive feedbacks from an “after a date” review.
The number of open messages the user has if it differs from the number of matches.
In a transparent rank system, the number of times a user reranks another user on on average.
In a transparent rank system, the number of times a user reranks the user assigned as most priority on average.

### Feedback System

One problem in traditional systems is a lack of feedback from other users' performance on dates. Although a slightly controversial issue, a review system could act as a hinderance to daters in that it advertises their dating (and possibly sexual) history, which would cause problems.

Furthermore, a traditional review system where users openly review each other could be open to manipulation from users who may apply unfair practices in reviewing others, reducing the inefficiency of the feature.

Therefore, this invention proposes a new method of users making reviews of each other.

The method consists of a review system where the users must collaborate together and agree on a joint review on their experience.

In some embodiments of the invention, the users will participate by taking turns to edit a shared agreed review between them.

In some embodiments of the invention, the users will be given pre-defined suggestions that they can both select their chosen option. Where there is agreement, the review will be approved and published. Where there is not agreement, the users will have a message area opened to discuss the differences of opinion and then come to an agreement.

In some embodiments of the system, the total number of reviews may be hidden and instead the ratio of agreed/disagreed reviews displayed.

This invention will help daters improve on their weaker points by receiving feedback from users who they have been on a date with. With both parties having to agree on a review to make it positive, the invention ensures that both users are fairly invested in collaborating to come to an agreement, rather than holding opinions after that are not discussed, or even such things as a user continuing ignorant behavior without being advised that it is an area for them to improve.

### Intentions System

One such problem in traditional systems, which is a very serious problem, is the misunderstanding of the intentions and desires of users when they are using the app or when they are meeting in real life.

When users post their data to state their intentions, it is done at the start when they sign up. Often, this data gets out of date, or is not valid for certain times when the user is using the app. Furthermore, some users have different intentions for different users. For example, some users may feel one person may be more suitable for a relationship, and another person for a sexual encounter.

Therefore, the first part of this invention is a method by which the user is forced to update their intentions status at regular intervals on the dating application.

In some embodiments of this part of the invention, the updated intentions may be requested each time the user logs into the app, or at a regular interval, or at certain times of the day, or at certain locations, or by some other means that may be deemed a useful point of update.

The second part of this invention is a method by which users can share what intention they would have with another user before a match is created.

In some embodiments of the invention the user would send a like, and with that like they would either send their own intentions to that user, or request what intentions that other user would have with them, and the other user respond back with that intention.

The third part of the invention is when a match is created, and the users are chatting. The users may have resulted in the matches area with intentions already set, but after conversation those intentions may have changed. So, in some embodiments of the invention the users can update their intentions live during chat to each other, a useful tool if users may be shy in sharing their feelings openly.

The fourth part of the invention is to show intentions when on a meeting or date in real life. In some embodiments of the invention, the users may have agreed a set of intentions before the date, and as the date gets better or worse, the users may update their intentions online in the app rather than verbally to indicate to the other user a change of feelings.

The fifth part of the invention is where the user may also use the app, whilst chatting before a meeting on the app and/or at some stage or during a meeting, their feelings regarding the desire to discuss consent or to show intent towards consent towards different physical interactions.

With many western countries moving to a 100% verbal explicit consent model (verbal agreement at every stage), and other countries still operating the traditional implied consent model (cues based on body language and behavior), the grey area between the two is often the reason for unwanted sexual attention for female or allegations of inappropriate behavior or even sexual assault for males.

Therefore, a method by which users can indicate desire to discuss consent or to show intent towards consent towards physical actions in a recorded application may be useful, particularly as used a recorded tool for users to record desires to discuss consent or to show intent towards consent for example for users who are shy to discuss such things face to face and would prefer to use a digital format to share the consent they would like to provide at that time to that user.

The recordings of desire to discuss consent or to show intent towards consent may then be helpful as parts of evidence of implied consent in legal cases where such evidence is required.

In some embodiments of the invention, the users can state through the app their agreements regarding the desire to discuss consent or to show intent towards consent of engaging in certain physical interactions with one another.

In some embodiments of the invention users may specify exactly what actions they are comfortable with engaging in at any time of the in-real-life meeting, covering intimate and sexual acts such as but not limited to holding hands and kissing to penetrative sex.

In some embodiments of the invention, the invention may also be used as a tool for recording incidents where the users have changed their desire to discuss consent or to show intent towards consent and need to provide recorded evidence of any incident that may have taken place.

In some embodiments of the invention the users may also update their desire to discuss consent or to show intent towards consent preferences in real time so they may change their desire to discuss consent or to show intent towards consent to certain physical interactions based upon their feelings at that time.

In some embodiments of the invention a change in desire to discuss consent or to show intent towards consent or could mean that both parties need to write a message, record a voice message, send a photo, or record a video to show or describe their location, status, state of mind, freedom from intoxication, safety, or other relevant information to assist in recording.

In some embodiments of the invention, the options may be wider than desire to discuss consent or to show intent towards consent, such as other means which provide useful aids for users to open discussions and define each other's preferences around intentions and consent.

In some embodiments of the invention, changes to the desire to discuss consent or to show intent towards consent or similar things discussed in this invention in a positive manner towards more physical consent would require a security clearance such as a password or biometric or other similar security to validate such changes, which could include a video recording to assess the users state of emotion to ensure the user is not under duress or intoxication or other similar state or situation that could invalidate the change of choice on the app.

In some embodiments of the invention, if the user changes intentions/consent change in the direction of removing consent may be done by a one push emergency button, such as like a panic button, that would immediately start recording audio and video or other similar means from their phone to document the situation.

In some embodiments of the invention, the invention may be used to recording audio or other media means during those actions consented to so that the user may have recorded evidence should they remove consent at any time.

In some embodiments of the invention, the invention may be voice activated based on a safe word, which would then activate video and audio recording and other similar data that could help the user prove their situation and possibly being under duress or other similar means.

In some embodiment of the invention, for features named above where recording data takes place, this may be audio, video, photographic, gps, personal health tracker data, or any part of data that may be available through the device, other connected devices.

In some embodiment of the system, the invention may be used to provided recorded advanced consent for sexual or other acts for couples or groups who are already familiar and have agreed to advance consent on some acts (a controversial subject but accepted in some western countries). This may be helpful in cases of partners in relationships who want to agree consent for sexual acts such as being touched while sleeping or acts during BDSM play where restrictions are played on participants ability to consent in the normal fashion.

Of course, users of the invention would be informed whilst the invention may offer an indication of the other users preferences of physical contact or other means, all users would be made unavoidably aware of the laws around consent and that the invention should only be used as an aid to interpret consent and not as a replacement for any sort of consent or lack of consent that may taking place in the moment or may change at any given moment.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

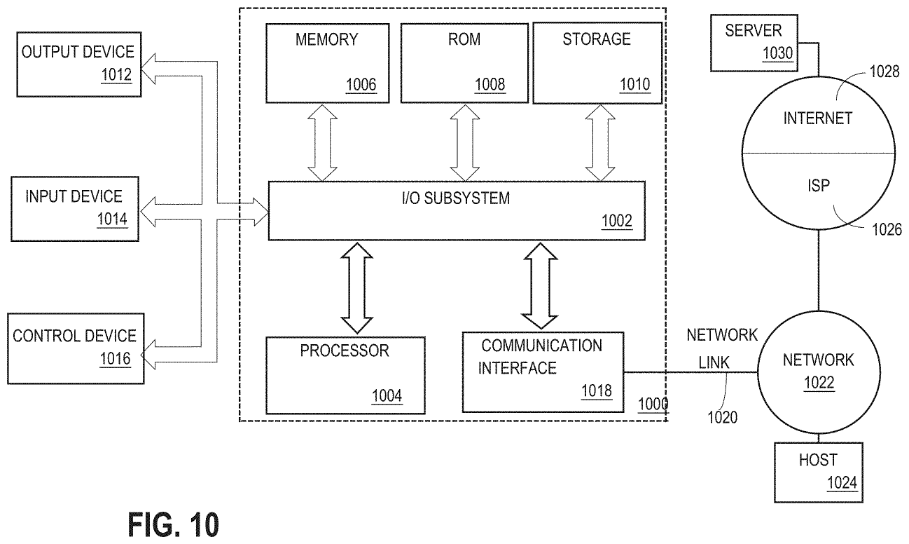

For example, FIG. 10 is a block diagram that illustrates a computer system 1000 upon which an embodiment of the invention may be implemented. Computer system 1000 includes a bus 1002 or other communication mechanism for communicating information, and a hardware processor 1004 coupled with bus 1002 for processing information. Hardware processor 1004 may be, for example, a general purpose microprocessor.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or solid-state drive is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1010. Volatile media includes dynamic memory, such as main memory 1006. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world wide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
causing display, on a display of a computing device, a first set of user interface controls to enable a first user to indicate interest in a second user;
causing display, on the display of the computing device, a second set of user interface controls to enable the first user to specify a particular rank of interest in the second user relative to interest of the first user in one or more other users;
causing display, on the display of the computing device, a third set of user interface controls to enable the first user to open a message with the second user only if each condition in a set of conditions is satisfied, wherein the set of conditions includes:
the particular rank is at least as high as a first threshold; and
a number of currently open messages of the first user is below a second threshold;
wherein the method is performed by one or more computing devices.

2. The method of claim 1 wherein the first threshold is the same the second threshold.

3. The method of claim 1 further comprising causing display of the particular rank on a display of a second computing device used by the second user.

4. The method of claim 3 further comprising:
receiving user input from the first user that changes the particular rank from a first value to a second value; and
in response to the user input, causing display of the particular rank on the display of the second computing device to change from the first value to the second value in real-time.

5. The method of claim 1 further comprising causing display of the number of currently open messages of the first user on a display of a second computing device used by the second user.

6. The method of claim 1 wherein the set of conditions further includes that the second user has assigned the first user a ranking that is at least as high as the first threshold.

7. The method of claim 1 wherein the second set of user interface controls enable the first user to specify the particular rank by selecting a non-numeric representation of rank.

8. The method of claim 7 wherein the non-numeric representation of rank includes a label or an image.

9. The method of claim 8 wherein the non-numeric representation is a user-editable label.

10. The method of claim 1 further comprising enabling a restricted amount of communication between the first user and the second user when at least one condition in the set of conditions is not satisfied.

11. The method of claim 1 further comprising causing display, to the second user, an average time the first user takes to open messages from other users.

12. The method of claim 1 wherein the set of conditions includes that the first user has, using the first set of user interface controls, specified an indication of interest in the second user.

13. The method of claim 12 wherein the set of conditions does not include that the first user has, using the first set of user interface controls, specified an indication of interest in the second user.

14. The method of claim 1 further comprising, in response to the first user specifying the particular rank, automatically re-ranking interests of the first user in one or more other users to ensure that all other users have a unique rank relative to the first user.

15. The method of claim 14 further comprising sending an indication to the one or more other users of their new ranking relative to the first user.

16. A system comprising:
one or more computing devices, each of which includes one or more processors and one or more storage devices;
instructions which, when executed by the one or more computing devices, cause:
display, on a display of a computing device, a first set of user interface controls to enable a first user to indicate interest in a second user;
display, on the display of the computing device, a second set of user interface controls to enable the first user to specify a particular rank of interest in the second user relative to interest of the first user in one or more other users;
display, on the display of the computing device, a third set of user interface controls to enable the first user to open a message with the second user only if each condition in a set of conditions is satisfied, wherein the set of conditions includes:
the particular rank is at least as high as a first threshold; and
a number of currently open messages of the first user is below a second threshold.

17. The system of claim 16 wherein the first threshold is the same the second threshold.

18. The system of claim 16 wherein the instructions further cause display of the particular rank on a display of a second computing device used by the second user.

19. The system of claim 18 wherein the instructions further cause:
receiving user input from the first user that changes the particular rank from a first value to a second value; and
in response to the user input, causing display of the particular rank on the display of the second computing device to change from the first value to the second value in real-time.

20. The system of claim 16 wherein the instructions further cause display of the number of currently open messages of the first user on a display of a second computing device used by the second user.
